(19) United States
(12) Patent Application Publication
(10) Pub. No.: US 2025/0078331 A1
(43) Pub. Date: Mar. 6, 2025

(54) METHOD FOR PROCESSING COMMENTS AND ELECTRONIC DEVICE

(71) Applicant: BEIJING DAJIA INTERNET INFORMATION TECHNOLOGY CO., LTD., Beijing (CN)

(72) Inventors: Yanhang JIN, Beijing (CN); Yayun ZUO, Beijing (CN); Qiu YANG, Beijing (CN); Ge SONG, Beijing (CN); Chen QIU, Beijing (CN); Shikun CHEN, Beijing (CN); Zhenkai YANG, Beijing (CN); Huichen YANG, Beijing (CN); Lu ZHANG, Beijing (CN); Bozhong HUANG, Beijing (CN); Senhua CHEN, Beijing (CN); Nan GAO, Beijing (CN)

(21) Appl. No.: 18/676,240

(22) Filed: May 28, 2024

(30) Foreign Application Priority Data
Sep. 5, 2023 (CN) 202311140943.X

(51) Int. Cl. G06T 11/00; G06F 3/0481; G06F 9/451

(52) U.S. Cl. CPC G06T 11/00; G06F 3/0481; G06F 9/451

(57) ABSTRACT

A method for processing comments includes: displaying a plurality of image-generating entries on a comment editing panel of a comment object, wherein the plurality of image-generating entries is configured to generate comment images for commenting the comment object by triggering different image-generating networks, each image-generating entry corresponds to an image-generating network, and the image-generating entry is configured to generate a comment image by triggering the image-generating network corresponding to the image-generating network.

This application is based on and claims priority to Chinese Patent Application No. 202311140943.X, filed on Sep. 5, 2023, the disclosure of which is herein incorporated by reference in its entirety.

### TECHNICAL FIELD

The present disclosure relates to the field of Internet technologies and in particular to a method for processing comments and an electronic device.

### BACKGROUND

With the development of Internet technologies and the popularization of mobile devices, using mobile devices to view multimedia content such as short videos and to purchase goods has become a part of people's daily life. Users usually make comments on the viewed multimedia content or purchased goods.

### SUMMARY

The present disclosure provides a method for processing comments and an electronic device. The technical solutions of the present disclosure are as follows.

According to some embodiments of the present disclosure, a method for processing comments is provided. The method includes:
displaying a plurality of image-generating entries on a comment editing panel of a comment object,
wherein the plurality of image-generating entries is configured to generate comment images for commenting the comment object by triggering different image-generating networks; each image-generating entry corresponds to an image-generating network, and the image-generating entry is configured to generate a comment image by triggering the image-generating network corresponding to the image-generating network.

According to some embodiments of the present disclosure, an electronic device is provided. The electronic device includes a processor and a memory configured to store instructions that, when executed by the processor, cause the processor to:
display a plurality of image-generating entries on a comment editing panel of a comment object,
wherein the plurality of image-generating entries is configured to generate comment images for commenting the comment object by triggering different image-generating networks; each image-generating entry corresponds to an image-generating network, and the image-generating entry is configured to generate a comment image by triggering the image-generating network corresponding to the image-generating network.

According to some embodiments of the present disclosure, a non-transitory computer-readable storage medium is provided. Instructions in the storage medium, when executed by a processor of an electronic device, cause the electronic device to:
display a plurality of image-generating entries on a comment editing panel of a comment object,
wherein the plurality of image-generating entries is configured to generate comment images for commenting the comment object by triggering different image-generating networks; each image-generating entry corresponds to an image-generating network, and the image-generating entry is configured to generate a comment image by triggering the image-generating network corresponding to the image-generating network.

### BRIEF DESCRIPTION OF THE DRAWINGS

FIG. 1 is a schematic diagram of an application environment according to some embodiments;

FIG. 2 is a flowchart of a method for processing comments according to some embodiments;

FIG. 3 is a schematic diagram of a comment editing panel according to some embodiments;

FIG. 4 is a schematic diagram of another comment editing panel according to some embodiments;

FIG. 5 is a schematic diagram of an initial comment editing panel according to some embodiments;

FIG. 6 is a schematic diagram of a process of generating at least one candidate image based on a text-based image-generating entry according to some embodiments;

FIG. 7 is a schematic diagram of a process of generating at least one candidate image based on an image-based image-generating entry according to some embodiments;

FIG. 8 is a schematic diagram of a process of generating at least one candidate image based on a graffiti-based image-generating entry according to some embodiments;

FIG. 9 is a schematic page diagram of a display page of at least one candidate image according to some embodiments;

FIG. 10 is a schematic page diagram of another display page of at least one candidate image according to some embodiments;

FIG. 11 is a schematic page diagram of yet another display page of at least one candidate image according to some embodiments;

FIG. 12 is a schematic diagram of posting of comment information based on a target comment image generated by triggering a text-based image-generating entry according to some embodiments;

FIG. 13 is a schematic diagram of posting of comment information based on a target comment image generated by triggering an image-based image-generating entry according to some embodiments;

FIG. 14 is a schematic diagram of posting of comment information based on a target comment image generated by triggering a graffiti-based image-generating entry according to some embodiments;

FIG. 15 is a block diagram of an apparatus for processing comments according to some embodiments; and

FIG. 16 is a block diagram of an electronic device for processing comments according to some embodiments.

### DETAILED DESCRIPTION

In order to make persons of ordinary skill in the art better understand the technical solutions of the present disclosure, the technical solutions in the embodiments of the present disclosure are described clearly and completely hereinafter with reference to the accompanying drawings.

It should be noted that user information (including but not limited to user device information, user personal information, etc.) and data (including but not limited to data for display, data for analysis, etc.) involved in the present disclosure are all information and data authorized by users or fully authorized by all parties.

Artificial intelligence (AI) technology is a comprehensive subject, which involves a wide range of fields, including hardware-level technology and software-level technology. The solutions provided by the embodiments of the present disclosure relate to the technology at the software level, in particular to the artificial intelligence generated content (AIGC) technology, namely, the AI-based content production technology, which is particularly described by the following embodiments.

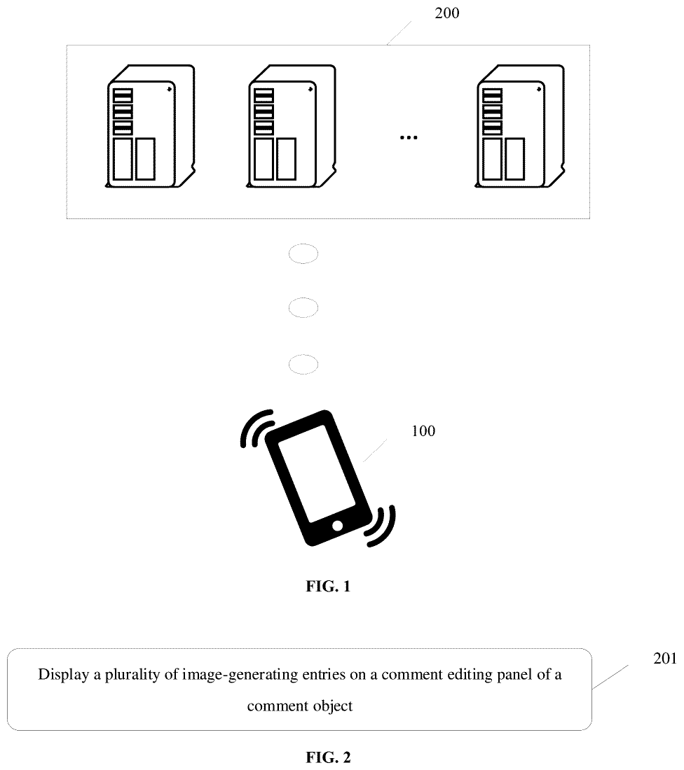

Referring to FIG. 1, FIG. 1 is a schematic diagram of an application environment according to some embodiments. The application environment includes a terminal 100 and a server 200.

In some embodiments, the terminal 100 is configured to provide business services such as comments for any user. In some embodiments, the terminal 100 includes, but is not limited to, a smart phone, a desktop computer, a tablet computer, a notebook computer, a smart loudspeaker, a digital assistant, an augmented reality (AR)/virtual reality (VR) device, a smart wearable device and other types of electronic devices, and may also be software running on the above electronic devices, such as applications. In some embodiments, operating systems running on the electronic devices include but are not limited to Android system, IOS system, linux, windows, etc.

In some embodiments, the server 200 provides a background service for the terminal 100. In some embodiments, the server 200 is a stand-alone physical server, a server cluster or a distributed system composed of multiple physical servers, and a cloud server providing a cloud computing service.

In addition, it should be noted that FIG. 1 only shows one application environment provided by the present disclosure; and in practical application, other application environments may be included, and for example, more terminals are included.

In the embodiments of the present disclosure, the terminal 100 and the server 200 are directly or indirectly connected through wired or wireless communication, which is not limited in the embodiments of the present disclosure herein.

In some practices, in addition to editing the text of the comments, users can often only edit the comment information by uploading pre-shot images or general emojis.

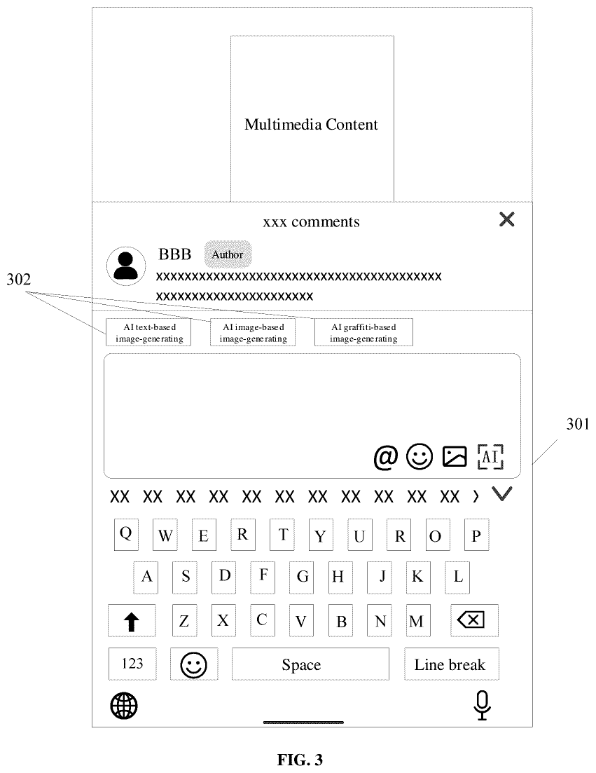

FIG. 2 is a flowchart of a method for processing comments according to some embodiments. The method is applicable to a terminal. As shown in FIG. 2, the method includes the following steps.

In 201, a plurality of image-generating entries is displayed on a comment editing panel of a comment object.

In some embodiments, the comment object is an object that needs to be commented. For example, the comment object is multimedia content such as a video, an image and a text, or a downloaded application and a purchased product.

In some embodiments, the plurality of image-generating entries is configured to generate comment images for commenting the comment object by triggering different image-generating networks. Each image-generating entry corresponds to an image-generating network, and the image-generating entry is configured to generate a comment image by triggering the image-generating network corresponding to the image-generating network. In some embodiments, the comment editing panel (a comment publisher) is configured to edit comment information. In some embodiments, the comment editing panel also displays operation information, such as an information input box, a voice input control, a keyboard and an emojis input control, for editing comment information.

In some embodiments, the plurality of image-generating entries includes at least two of a text-based image-generating entry, an image-based image-generating entry, a graffiti-based image-generating entry and an image-and-text-based image-generating entry.

In some embodiments, an image-generating network corresponding to the text-based image-generating entry is a text-based image-generating network, which is used for generating an image based on text information. In some embodiments, the text-based image-generating network is acquired by performing image generation training on a first generative network based on a sample text information and a labeled image corresponding to the sample text information. Correspondingly, the text-based image-generating entry is configured to generate a comment image based on the text-based image-generating network.

In some embodiments, an image-generating network corresponding to the image-based image-generating entry is an image-based image-generating network, which is used for generating an image based on an image. In some embodiments, the image-based image-generating network is acquired by performing image generation training on a second generative network based on a sample image and a labeled image corresponding to the sample image. Correspondingly, the image-based image-generating entry is configured to generate a comment image based on the image-based image-generating network.

In some embodiments, an image-generating network corresponding to the graffiti-based image-generating entry is a graffiti-based image-generating network, which is used for generating an image based on a graffiti image. In some embodiments, the graffiti-based image-generating network is acquired by performing image generation training on a third generative network based on a sample graffiti image and a labeled image corresponding to the sample graffiti image. Correspondingly, the graffiti-based image-generating entry is configured to generate a comment image based on the graffiti-based image-generating network.

In some embodiments, an image-generating network corresponding to the image-and-text-based image-generating entry is an image-and-text-based image-generating network, which is used for generating an image based on image-and-text information including an image and text information. In some embodiments, the image-and-text-based image-generating network is acquired by performing image generation training on a fourth generative network based on sample image-and-text information and a labeled image corresponding to the sample image-and-text information. Correspondingly, the image-and-text-based image-generating entry is configured to generate a comment image based on the image-and-text-based image-generating network.

In addition, it should be noted that the first generative network, the second generative network, the third generative network and the fourth generative network are preset generative artificial intelligence networks; and the specific network structure of each network is set in combination with practical applications. In some embodiments, taking the generation of a countermeasure network as an example, correspondingly, the text-based image-generating network, the image-based image-generating network, the graffiti-based image-generating network and the image-and-text-based image-generating network are a trained generator for generating the countermeasure network.

In the above embodiments, by providing at least two of the text-based image-generating entry, the image-based image-generating entry, the graffiti-based image-generating entry and an image-and-text-based image-generating entry, the user adopts an artificial intelligence image-generating function in the comment editing process conveniently, thereby improving the variety of the artificial intelligence image-generating function.

In some embodiments, in the case that the displaying of the comment editing panel is triggered, the plurality of image-generating entries is simultaneously displayed. Correspondingly, a process of displaying the plurality of image-generating entries on the comment editing panel of the comment object includes: displaying the comment editing panel including the plurality of image-generating entries in response to a comment triggering instruction for the comment object.

In some embodiments, the comment triggering instruction is an instruction to trigger the display of the comment editing panel, and correspondingly, the user edits comment information in combination with the comment editing panel. In some embodiments, the comment triggering instruction is triggered by performing operations such as clicking or long pressing a comment trigger control corresponding to the comment object.

In some embodiments, the above method further includes: displaying an initial comment editing panel in response to the comment triggering instruction for the comment object, the initial comment editing panel is provided with entry triggering information. Correspondingly, the above process of displaying the plurality of image-generating entries on the comment editing panel of the comment object includes: updating the initial comment editing panel as the comment editing panel provided with the plurality of image-generating entries in response to an entry displaying instruction triggered based on the entry triggering information.

In some embodiments, the above entry triggering information is configured to display the plurality of image-generating entries. For example, by clicking or long pressing the entry triggering information and other operations, the above entry displaying instruction is triggered.

In some embodiments, for example, the comment object is the multimedia content, and the plurality of image-generating entries includes the text-based image-generating entry, the image-based image-generating entry and the graffiti-based image-generating entry, as shown in FIG. 3, which is a schematic diagram of a comment editing panel according to some embodiments. The terminal displays a comment editing panel 301, which includes a plurality of image-generating entries 302.

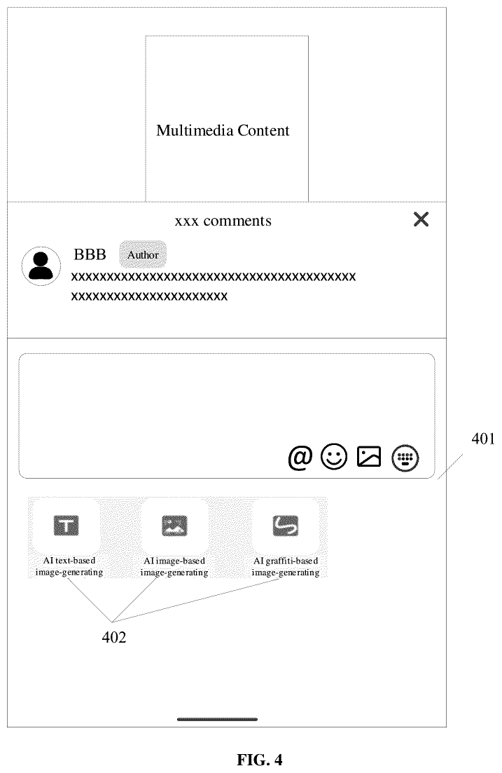

In some embodiments, for example, the comment object is the multimedia content, and the plurality of image-generating entries includes the text-based image-generating entry, the image-based image-generating entry and the graffiti-based image-generating entry, as shown in FIG. 4, which is a schematic diagram of another comment editing panel according to some embodiments. The terminal displays a comment editing panel 401, which includes a plurality of image-generating entries 402.

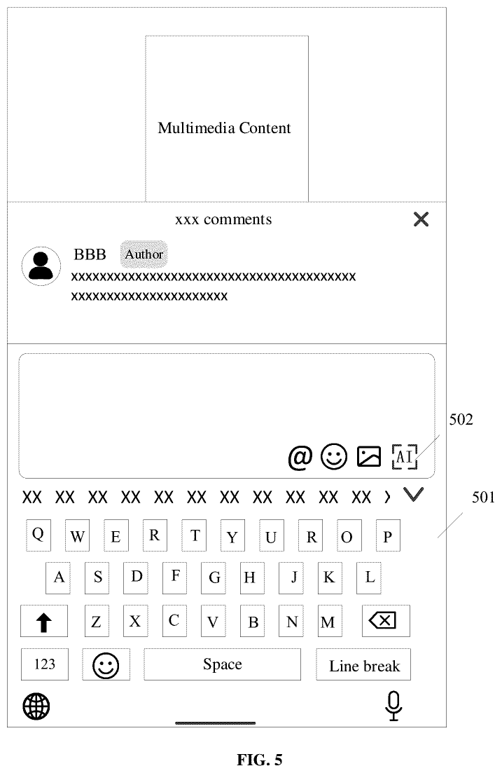

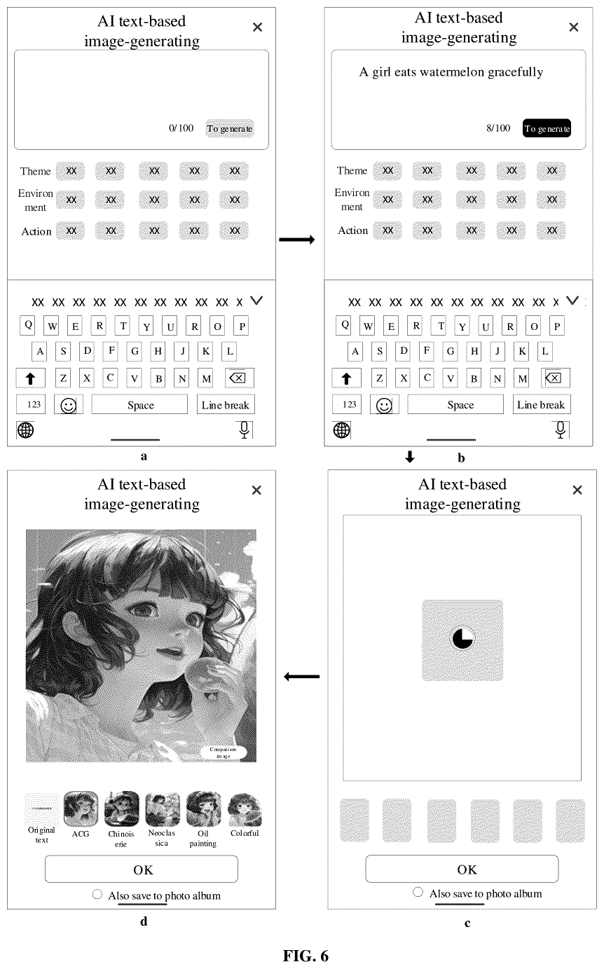

In some embodiments, taking the multimedia content as an example, as shown in FIG. 5, which is a schematic diagram of an initial comment editing panel according to some embodiments. The terminal displays an initial comment editing panel 501, which includes entry triggering information 502.

In some embodiments, when the displaying of the comment editing panel is triggered, the plurality of image-generating entries is simultaneously displayed; or when the comment triggering instruction is triggered, the entry triggering information is displayed, and then, the plurality of image-generating entries is displayed in combination with the entry triggering information, such that not only is the artificial intelligence image-generating function enriched, but also the variety of triggering of the artificial intelligence image-generating function is increased.

In some embodiments, the above method further includes: in the case that a target comment image is generated by triggering a target image-generating entry, displaying the target comment image on the comment editing panel, and displaying comment information including the target comment image on a comment displaying region of the comment object in response to a comment posting instruction.

The target image-generating entry is any one of the plurality of image-generating entries, and the target comment image is generated based on an image-generating network corresponding to the target image-generating entry.

In some embodiments, in the case that the target comment image is generated by triggering the target image-generating entry, displaying the target comment image on the comment editing panel includes: displaying operation information in response to an image-generating triggering instruction triggered based on the target image-generating entry; in the case that image description information is acquired by editing based on the operation information and an image-generating confirming instruction is triggered, displaying at least one candidate image, which is generated based on the image description information and the image-generating network corresponding to the target image-generating entry; and displaying the target comment image on the comment editing panel in response to an image confirming instruction for the target comment image, wherein the target comment image is any image from the at least one candidate image.

In some embodiments, the image-generating entry is an operable control. Correspondingly, the above image-generating triggering instruction is triggered by an interactive operation for the target image-generating entry, for example, clicking on the target image-generating entry, or long pressing the target image-generating entry, or the like. Or, the image-generating triggering instruction is triggered based on the interactive operation indicated in the target image-generating entry. For example, the target image-generating entry is the text-based image-generating entry, and the text-based image-generating entry includes interactive indication information of “shaking the device to enable the AI text-based image-generating function”; and correspondingly, the image-generating triggering instruction is triggered by shaking the device. Or, according to the interactive operation for triggering the image-generating triggering instruction indicated in the target image-generating entry, the above image-generating triggering instruction is triggered by operating the external device.

In some embodiments, the operation information is used for editing image description information. For example, the image description information is information describing an image to be generated, namely, input information of an image-generating network. In some embodiments, the operation information is displayed on the comment editing panel, or the comment editing panel is turned to a new page on which the operation information is displayed. Correspondingly, at least one candidate image is displayed on the comment editing panel, or the comment editing panel is turned to a new page on which the at least one candidate image is displayed.

In some embodiments, in the case that the target image-generating entry is a text-based image-generating entry, the above image description information is edited text information; and the image-generating network corresponding to the target image-generating entry is a text-based image-generating network, and the at least one candidate image is generated based on the edited text information and the text-based image-generating network.

In some embodiments, in the case that the above target image-generating entry is the text-based image-generating entry, the operation information is text editing operation information. For example, the text editing operation information includes a text input box. Correspondingly, the above edited text information includes text information input based on the text input box. For another example, the text editing operation information includes image theme selection information, image action selection information and image environment selection information. The image theme selection information includes a plurality of pieces of selectable theme information, which is set in accordance with practical applications. The image action selection information includes a plurality of pieces of selectable action information, which is set in accordance with practical applications. The image environment selection information includes a plurality of pieces of selectable environment information, which is set in accordance with practical applications. Correspondingly, the above edited text information includes selected theme information, selected action information and selected environment information.

In some embodiments, the at least one candidate image is acquired by inputting the edited text information into the text-based image-generating network for image generation processing.

In the above embodiments, in the case that the target image-generating entry is the text-based image-generating entry, the application of the artificial intelligence text-based image generation in the comment process is realized by editing the text information and performing the image generation processing with the text information as the input of the text-based image-generating network, such that the richness and the interest of the comment information are increased, and meanwhile, the users are effectively stimulated to make comments and interact with one another, thereby improving the interactivity.

In some embodiments, in the case that the target image-generating entry is an image-based image-generating entry, the image description information is a selected reference image; and the image-generating network corresponding to the target image-generating entry is an image-based image-generating network, and the at least one candidate image is generated based on the selected reference image and the image-based image-generating network.

In some embodiments, in the case that the above target image-generating entry is the image-based image-generating entry, the operation information is a picture select operation information. For example, the picture select operation information includes an image source select control and images corresponding to the image source select control, such that currently selectable reference images are selected in combination with the image source select control. Further, the reference image is selected by clicking any one of the currently selectable reference images.

In some embodiments, the at least one candidate image is acquired by inputting the selected reference image into the image-based image-generating network for image generation processing.

In the above embodiments, in the case that the target image-generating entry is the image-based image-generating entry, the application of the artificial intelligence image-based image generation in the comment process is realized by selecting the reference image and performing the image generation processing with the reference image as the input of the image-based image-generating network, such that the richness and interest of the comment information are further improved, and meanwhile, the users are effectively stimulated to make comments and interact with one another, thereby improving the interactivity.

In some embodiments, in the case that the target image-generating entry is a graffiti-based image-generating entry, the image description information is an edited graffiti image; and the image-generating network corresponding to the target image-generating entry is a graffiti-based image-generating network, and the at least one candidate image is generated based on the edited graffiti image and the graffiti-based image-generating network.

In some embodiments, in the case that the above target image-generating entry is the graffiti-based image-generating entry, the operation information is graffiti operation information. In some embodiments, the graffiti operation information is used for making graffiti images, and for example, is a sketchpad, a brush, etc.

In some embodiments, the at least one candidate image is acquired by inputting the edited graffiti image into the graffiti-based image-generating network for image generation processing.

In the above embodiments, in the case that the target image-generating entry is the graffiti-based image-generating entry, the application of the artificial intelligence graffiti-based image generation in the comment process is realized by editing the graffiti image and performing the image generation processing with the graffiti image as the input of the graffiti-based image-generating network, such that the richness and interest of the comment information are further improved, and meanwhile, the users are effectively stimulated to make comments and interact with one another, thereby improving the interactivity.

In some embodiments, in the case that the target image-generating entry is an image-and-text-based image-generating entry, the above image description information is edited image-and-text information; and the image-generating network corresponding to the target image-generating entry is an image-and-text image-generating network, and the at least one candidate image is generated based on the edited image-and-text information and the image-and-text-based image-generating network.

In some embodiments, in the case that the above target image-generating entry is the image-and-text-based image-generating entry, the operation information includes text editing operation information and image editing operation information. The image-and-text information includes edited text information and an edited image. The specific details of the text editing operation information and the text information may refer to the above related steps, and are not repeated herein.

In some embodiments, the image editing operation information includes at least one of graffiti operation information or picture select operation information. Correspondingly, the edited image includes an edited graffiti image or a selected reference image. The specific details of the graffiti operation information, picture select operation information, edited graffiti image and selected reference image may refer to the above related steps, and are not repeated herein.

In some embodiments, the at least one candidate image is acquired by inputting the edited image-and-text information into the image-and-text-based image-generating network for image generation processing.

In the above embodiments, in the case that the target image-generating entry is the image-and-text-based image-generating entry, the application of the artificial intelligence image-and-text-based image generation in the comment process is realized by editing the image-and-text information and performing the image generation processing with the image-and-text information as the input of the image-and-text-based image-generating network, such that the richness and interest of the comment information are further improved, and meanwhile, the users are effectively stimulated to make comments and interact with one another, thereby improving the interactivity.

In some embodiments, in the case that the image description information is acquired by editing based on the operation information and an image-generating confirming instruction is triggered, the terminal sends an image-generating quest with the image description information to the server. Correspondingly, the server generates at least one candidate image in combination with the image description information and the image-generating network, and returns the at least one candidate image to the terminal, such that a terminal displays the at least one candidate image.

In some embodiments, in combination with FIG. 3, it is assumed that the target image-generating entry is an “AI text-based image-generating” control (a text-based image-generating entry), and as shown in FIG. 6, FIG. 6 is a schematic diagram of a process of generating at least one candidate image based on the text-based image-generating entry according to some embodiments. In FIG. 6, a shows a display page of text editing operation information; further, b in FIG. 6 shows edited text information “A girl eats watermelon gracefully” displayed on the display page; further, if the image-generating confirming instruction is triggered based on a “to generate” control in the text editing operation information, c in FIG. 6 shows a generation progress displayed on the display page while the at least one candidate image is being generated; and further, when the at least one candidate image has been generated, d in FIG. 6 shows that the at least one generated candidate image is displayed on the display page.

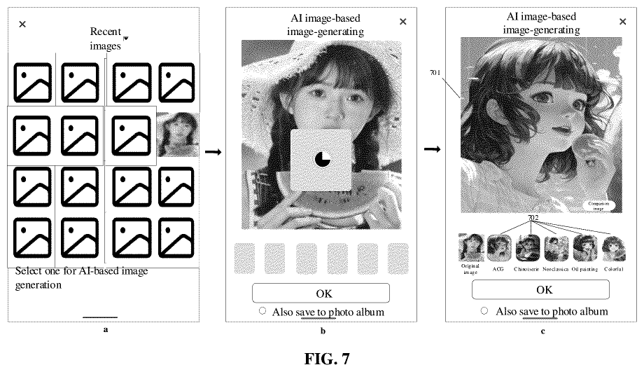

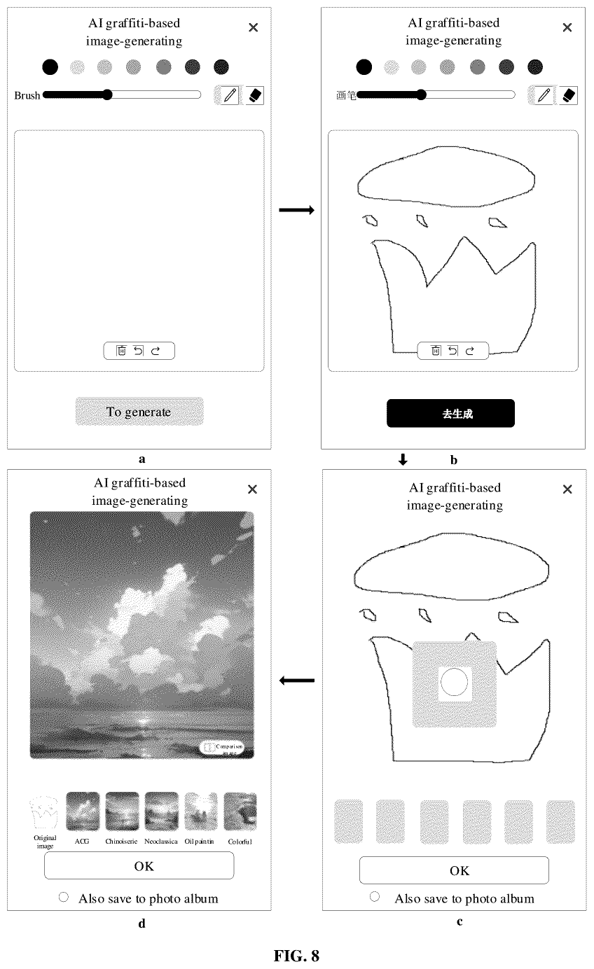

In some embodiments, in combination with FIG. 3, it is assumed that the target image-generating entry is an “AI image-based image-generating” control (an image-based image-generating entry), and as shown in FIG. 7, FIG. 7 is a schematic diagram of a process of generating at least one candidate image based on an image-based image-generating entry according to some embodiments. In FIG. 7, a shows a display page of picture select operation information. Further, it is assumed that an image of a girl eating a watermelon is selected and the image-generating confirming instruction is triggered, b in FIG. 7 shows a generation progress displayed on this display page while the at least one candidate image is being generated; and further, when the at least one candidate image has been generated, c in FIG. 7 shows that the at least one generated candidate image is displayed on the display page.

In some embodiments, in combination with FIG. 3, it is assumed that the target image-generating entry is an “AI graffiti-based image-generating” control (a graffiti-based image-generating entry), and as shown in FIG. 8, FIG. 8 is a schematic diagram of a process of generating at least one candidate image based on the graffiti-based image-generating entry according to some embodiments. In FIG. 8, a shows a display page of graffiti operation information; further, b in FIG. 8 shows an edited graffiti image displayed on the display page; further, if the image-generating confirming instruction is triggered based on a “to generate” control in the graffiti operation information, c in FIG. 8 shows a generation progress displayed on the display page while the at least one candidate image is being generated; and further, when the at least one candidate image has been generated, d in FIG. 8 shows that the at least one generated candidate image is displayed on the display page.

In some embodiments, images of a plurality of different image styles are generated at a time, and correspondingly, the at least one candidate image may include candidate images of a plurality of first styles. Correspondingly, the process of displaying the at least one candidate image includes: displaying a first candidate image and a first style switch control corresponding to each of the plurality of first styles. The above first candidate image is a candidate image of a first target style in the plurality of first styles; and any first style switch control is configured to switch a currently displayed candidate image to a candidate image of the first style corresponding to the first style switch control. In some embodiments, the first target style is an image style that is displayed first by default. Correspondingly, the currently displayed candidate image is the first candidate image in an initial state. In some embodiments, the plurality of first styles are a plurality of preset image styles, are set in combination with practical applications, and for example, includes an animation, comic, game (ACG) style, a chinoiserie style, a neoclassical style, an oil painting style, a colorful style, etc.

In some embodiments, the currently displayed candidate image is triggered to be switched to the candidate image of the first style corresponding to the first style switch control by clicking any first style switch control, or is switched to the candidate image of another first style to be displayed by sliding the currently displayed candidate image or other operations.

In some embodiments, for example, the target image-generating entry is the image-based image-generating entry, and the first target style is the ACG style; and in combination with FIG. 7, the terminal displays a first candidate image 701 and a plurality of first style switch controls 702 corresponding to the plurality of first styles. In combination with FIG. 7, it can be seen that a display page of the at least one candidate image further displays an original switch control (a selected reference image switch control), a comment image confirm control (an “OK” control), a comparison confirm control, etc. Correspondingly, a currently displayed candidate image is triggered to be switched to a selected reference image in combination with the original switch control, or the selected reference image is triggered to be displayed by sliding the currently displayed candidate image or other operations. The comparison confirm control is in a selected state or in a non-selected state. In the selected state, after a target comment image for commenting is selected from the candidate images and a comment posting instruction is triggered, comment information includes not only a selected candidate image (a target comment image), but also an original image (the selected reference image). On the other hand, in the non-selected state, after the target comment image for commenting is selected from the candidate images and the comment posting instruction is triggered, the comment information only includes the selected candidate image (the target comment image) and does not include the original image (the selected reference image).

In the above embodiments, the images of the different image styles are generated at a time, such that in combination with the switch controls corresponding to the different image styles respectively, the users can conveniently select the images of the different image styles as comment images according to needs, thereby improving the variety of selection of the comment images.

In some embodiments, a single image of a certain image style is generated. Correspondingly, the at least one candidate image includes a second candidate image which is a candidate image of a second target style in a plurality of second styles; and a process of displaying the at least one candidate image includes: displaying the second candidate image and at least one of a displaying style adjust control, a first image update control or a second style switch control corresponding to each of the plurality of second styles. The style adjust control is used for adjusting intensity of an image style of a currently displayed candidate image; the first image update control, after being triggered, is used for updating the currently displayed candidate image, and an image style of the updated candidate image is consistent with the image style of the currently displayed candidate image. That is, a candidate image having the image style consistent with the current image style may be switched to be displayed by means of the first image update control, which may be understood as only changing the image content without changing the image style. Any second style switch control, after being triggered, is used for switching the currently displayed candidate image to a candidate image of the second style corresponding to the second style switch control. In some embodiments, when triggered for the first time, the second style switch control corresponding to a second non-target style, after being triggered, is further used for generating a candidate image of the second non-target style; and the second non-target style is any one of the plurality of second styles except the second target style. The second target style may be an image style that is displayed first by default. Correspondingly, the currently displayed candidate image is the second candidate image in an initial state. In some embodiments, the plurality of second styles may be a plurality of preset image styles, may be set in combination with practical applications, and for example, includes an ACG style, a chinoiserie style, a neoclassical style, an optimized style, etc.

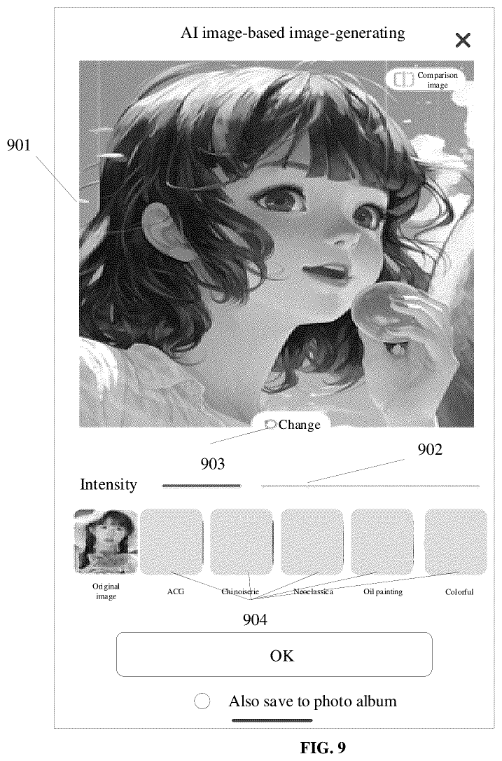

In some embodiments, for example, the target image-generating entry is the image-based image-generating entry, and the second target style is the ACG style. As shown in FIG. 9, FIG. 9 is a schematic page diagram of a display page of at least one candidate image according to some embodiments. In the figure, the terminal displays a second candidate image 901, a style adjust control 902, a first image update control 903, and a plurality of second style switch controls 904 corresponding to the plurality of second styles. A preset image corresponding to an image style is displayed in the second style switch control. In combination with FIG. 9, it can be seen that the display page of the at least one candidate image further displays an original switch control (a selected reference image switch control), a comment image confirm control (an “OK” control), a comparison confirm control, etc.

In the above embodiments, a single image of a certain image style is generated at first, and the style adjust control, the first image update control and the second style switch control corresponding to each of the plurality of second styles are displayed on the display page of the candidate images, such that the intensity of the image style can be adjusted conveniently, different images of the same style can be generated, and meanwhile, in combination with the switch control corresponding to each of the plurality of different image styles, the users can conveniently select candidate images of different styles and different candidate images of the same style as comment images according to requirements, thereby greatly improving the flexibility of selection of different candidate images of different styles.

In some embodiments, a plurality of images of a certain image style is generated at a time. Correspondingly, the at least one candidate image includes a plurality of third candidate images, which are candidate images of a third target style in a plurality of third styles. Thus, displaying the at least one candidate image includes: displaying the plurality of third candidate images and a third style switch control corresponding to each of the plurality of third styles. Any third style switch control is configured to switch the plurality of currently displayed candidate images to a plurality of candidate images of the third style corresponding to the third style switch control. In some embodiments, the third style switch control corresponding to a third non-target style, in a case of being triggered for a first time, is further configured to generate a plurality of candidate images of the third non-target style; and the third non-target style is any one of the plurality of third styles except the third target style. The third target style is an image style that is displayed first by default. Correspondingly, the plurality of currently displayed candidate images is the plurality of third candidate image in an initial state. In some embodiments, the plurality of third styles are a plurality of preset image styles, may be set in combination with practical applications, and for example, includes an ACG style, a chinoiserie style, a neoclassical style, an optimized style, a colorful style, etc.

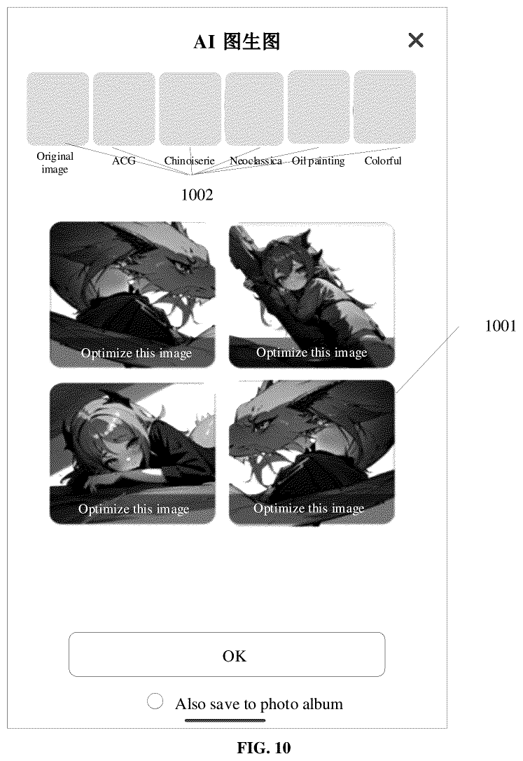

In some embodiments, for example, the target image-generating entry is the image-based image-generating entry, and the third target style is the ACG style. As shown in FIG. 10, FIG. 10 is a schematic page diagram of another display page of at least one candidate image according to some embodiments. In the figure, the terminal displays a plurality of third candidate images 1001, and a plurality of third style switch controls 1002 corresponding to the plurality of third styles respectively. A preset image corresponding to an image style is displayed in the third style switch control. In combination with FIG. 10, it can be seen that the display page of the at least one candidate image further displays an image optimize control (a control to “optimize this image”), a comment image confirm control (an “OK” control), a comparison confirm control, etc. Correspondingly, the candidate image is optimized in combination with the triggering of the image optimize control, and the candidate image is updated into an optimized candidate image.

In the above embodiments, a plurality of images of a certain image style is generated at first, and the third style switch controls corresponding to the plurality of third styles respectively are displayed while the plurality of third candidate images is displayed on the display page of the candidate images, such that in combination with the switch control corresponding to each of the plurality of different image styles, the users can conveniently select candidate images of different styles and different candidate images of the same style as comment images according to requirements, thereby improving the variety of selection of the comment images.

In some embodiments, images of a plurality of preset styles are generated, and the same images of a plurality of preset styles are switched by one clicking. Correspondingly, the at least one candidate image includes candidate images of a plurality of fourth styles. Correspondingly, the process of displaying the at least one candidate image includes: displaying candidate images of the plurality of fourth styles and a second image update control. The second image update control is configured to update currently displayed candidate images of the plurality of fourth styles. In some embodiments, the plurality of fourth styles are a plurality of preset image styles, may be set in combination with practical applications, and for example, includes an ACG style, a chinoiserie style, a neoclassical style, an optimized style, a colorful style, etc.

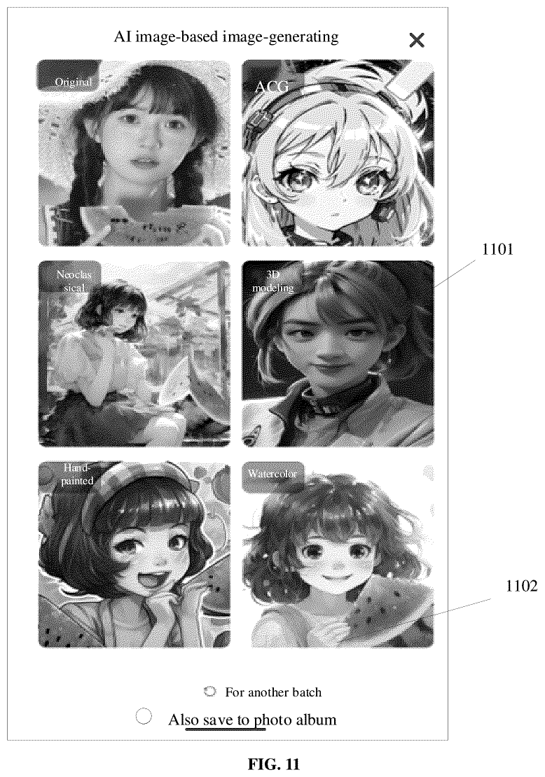

In some embodiments, for example, the target image-generating entry is the image-based image-generating entry, and the fourth target style is the ACG style. As shown in FIG. 11, FIG. 11 is a schematic page diagram of another display page of at least one candidate image according to some embodiments. In the figure, the terminal displays candidate images 1101 of a plurality of fourth styles and a second image update control 1102.

In the above embodiments, images of a plurality of preset styles are generated at first, and the second image update control is displayed on the display page of the candidate images, such that the other same images of the plurality of preset styles are switched by one clicking, and the users can conveniently select candidate images of different styles and different candidate images of the same style as comment images according to requirements, thereby greatly improving the flexibility of selection of different candidate images of the different styles.

In some embodiments, the user triggers an image confirming instruction for the target comment image on the display page of the at least one candidate image, such that the target comment image can be displayed on the comment editing panel. Taking c in FIG. 7 as an example, the image confirming instruction is triggered by clicking the “OK” control; and correspondingly, the candidate image currently displayed when the image confirming instruction is triggered is the target comment image.

In the above embodiments, the operation information is displayed in combination with the image-generating triggering instruction triggered by the target image-generating entry, and then, the image description information is acquired after editing in combination with the operation information. In addition, when an image-generating confirming instruction is triggered, at least one candidate image generated based on the image description information and the image-generating network corresponding to the target image-generating entry is displayed. When a user confirms that one of the candidate images is the target comment image, the target comment image is displayed on the comment editing panel, such that the comment image can be generated based on artificial intelligence in the comment process, thereby increasing the richness and interest of the comment information.

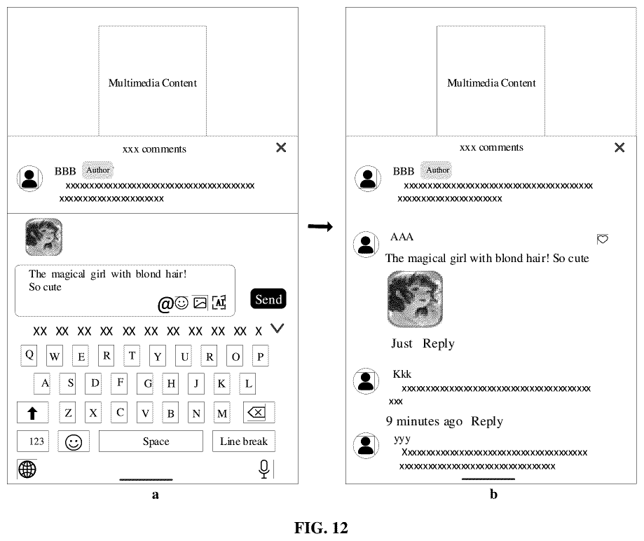

In some embodiments, taking the embodiment of FIG. 6 as an example, it is assumed that an image confirming instruction of a candidate image for the ACG style is triggered on the display page of d in FIG. 6, and as shown in FIG. 12, FIG. 12 is a schematic diagram of posting of comment information based on a target comment image generated by triggering a text-based image-generating entry according to some embodiments. In FIG. 12, a is a target comment image displayed on the comment editing panel. Further, when text comment content of “The magical girl with blond hair! So cute” is edited on the comment editing panel in a of FIG. 12, a comment posting instruction is triggered by clicking a “send” control or by other operations. Correspondingly, as shown in b of FIG. 12, comment information including the target comment image is displayed in a comment displaying area of a comment object.

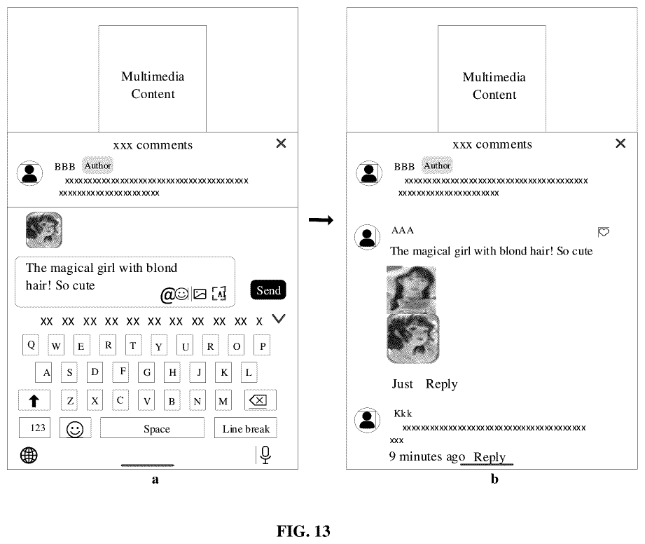

In some embodiments, taking the embodiment of FIG. 7 as an example, it is assumed that an image confirming instruction of a candidate image for the ACG style is triggered on the display page of c in FIG. 7, and as shown in FIG. 13, FIG. 13 is a schematic diagram of posting of comment information based on a target comment image generated by triggering an image-based image-generating entry according to some embodiments. In FIG. 13, a is a target comment image displayed on the comment editing panel. Further, when text comment content of “The magical girl with blond hair! So cute” is edited on the comment editing panel in a of FIG. 13, a comment posting instruction is triggered by clicking a “send” control or by other operations. Further, as shown in the schematic diagram of a comment displaying area shown by b in FIG. 13, the target comment image for making a comment is selected from the candidate images under the condition that the comparison confirm control is selected; and correspondingly, after the comment posting instruction is triggered, the comment information includes the target comment image and an original image (a selected reference image).

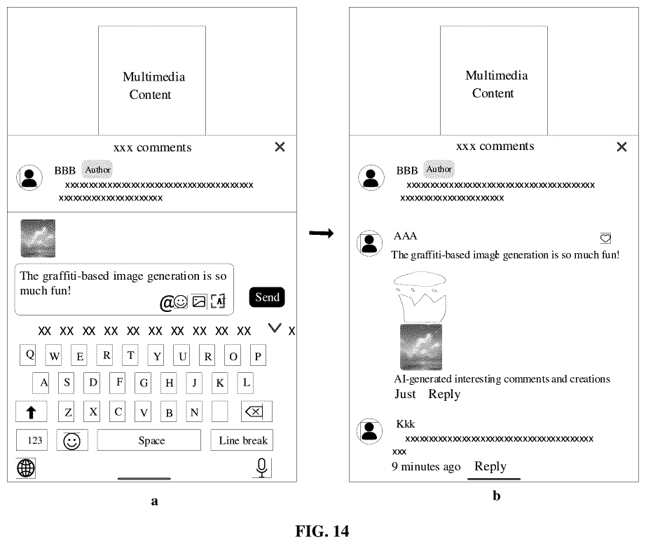

In some embodiments, taking the embodiment of FIG. 8 as an example, it is assumed that an image confirming instruction of a candidate image for the ACG style is triggered on the display page of d in FIG. 8, and as shown in FIG. 14, FIG. 14 is a schematic diagram of posting of comment information by a target comment image generated by triggering a graffiti-based image-generating entry according to some embodiments. In FIG. 14, a shows that a target comment image is displayed on the comment editing panel. Further, when text comment content of “The graffiti-based image generation is so much fun” is edited on the comment editing panel of a in FIG. 14, a comment posting instruction is triggered by clicking a “send” control or by other operations. Further, as shown in the schematic diagram of a comment displaying area shown by b in FIG. 14, the target comment image for making a comment is selected from the candidate images under the condition that the comparison confirm control is selected; and correspondingly, after the comment posting instruction is triggered, the comment information includes the target comment image and an original image (a selected reference image).

In the above embodiments, when the target comment image is generated by triggering the target image-generating entry, the target comment image is displayed on the comment editing panel based on an image-generating network corresponding to the target image-generating entry; and when the comment posting instruction is triggered, the comment information including the target comment image is displayed in the comment displaying area of the comment object, such that in the comment editing process, the comment information is edited by combining the AI image-generating function, thereby improving the richness and interest of the comment information.

In practical applications, in order to ensure the user experience, a new function is often developed to users step by step. Before the AI image-generating function is developed to all users, a reservation label of the AI image-generating function is displayed in the comment information, and the users can reserve this AI image-generating function by clicking the reservation label. As shown in FIG. 14, information corresponding to “AI-generated interesting comments and creations” is the reservation label of the AI image-generating function.

In some embodiments, the full-screen displaying of the target comment image is triggered by clicking the target comment image in the comment information. A full-screen display page of the target comment image displays the above reservation label of the AI image-generating function.

From the technical solutions provided by the embodiments of the present disclosure, it can be concluded that: as a plurality of image-generating entries is displayed in the comment editing panel of the comment object, application of AI image generation in the comment process is realized, the novelty and interest of the commenting method are improved and the AI image-generating function in the comment process is also enriched. In addition, by displaying a plurality of image-generating entries in the comment editing panel, users can access the AI image-generating function more conveniently. Users can conveniently use multiple AI image-generating functions during a comment editing process, such that the users are effectively stimulated to make comments and interact with one another, and the users can better understand the comment object in combination with the comment information.

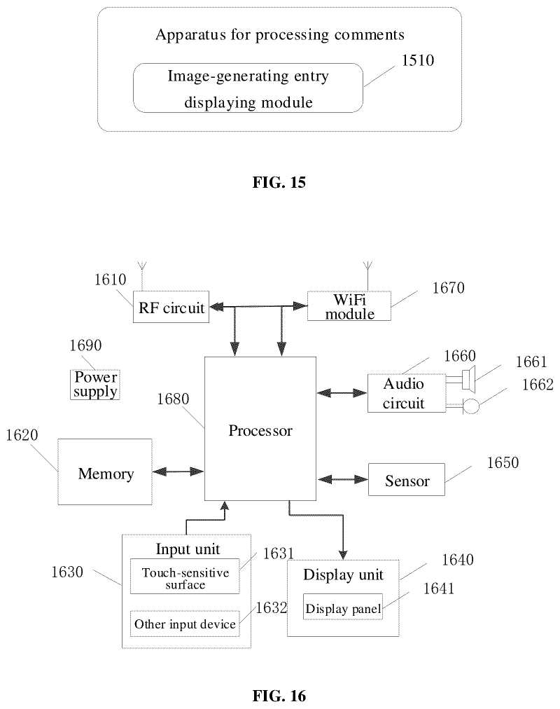

FIG. 15 is a block diagram of an apparatus for processing comments according to some embodiments of the present disclosure. Referring to FIG. 15, the apparatus includes:
an image-generating entry displaying module 1510 configured to display a plurality of image-generating entries on a comment editing panel of a comment object,
wherein the plurality of image-generating entries is configured to generate comment images for commenting the comment object by triggering different image-generating networks; each image-generating entry corresponds to an image-generating network, and the image-generating entry is configured to generate a comment image by triggering the image-generating network corresponding to the image-generating network.

In some embodiments, the plurality of image-generating entries includes at least two of a text-based image-generating entry, an image-based image-generating entry, a graffiti-based image-generating entry and an image-and-text-based image-generating entry.

In some embodiments, the image-generating entry displaying module 1510 includes:
a first displaying unit configured to display the comment editing panel provided with the plurality of image-generating entries in response to a comment triggering instruction for the comment object.

In some embodiments, the above apparatus further includes:
a panel displaying module configured to display an initial comment editing panel in response to a comment triggering instruction for the comment object, wherein the initial comment editing panel is provided with entry triggering information; and
the image-generating entry displaying module 1510 includes:
a second displaying unit configured to update the initial comment editing panel as the comment editing panel provided with the plurality of image-generating entries in response to an entry displaying instruction triggered based on the entry triggering information.

In some embodiments, the above apparatus further includes:
an image displaying module configured to: display a target comment image on the comment editing panel in response to generating the target comment image by triggering a target image-generating entry, wherein the target image-generating entry is any one of the plurality of image-generating entries, and the target comment image is generated based on an image-generating network corresponding to the target image-generating entry; and
a comment information displaying module configured to display, in response to a comment posting instruction, comment information including the target comment image on a comment displaying region of the comment object.

In some embodiments, the image displaying module includes:
an operation information displaying unit configured to display operation information in response to triggering an image-generating triggering instruction based on the target image-generating entry;
a candidate image displaying unit configured to: in response to acquiring image description information by editing based on the operation information and triggering an image-generating confirming instruction, display at least one candidate image, wherein the at least one candidate image is generated based on the image description information and the image-generating network corresponding to the target image-generating entry; and
a comment image displaying unit configured to display the target comment image on the comment editing panel in response to an image confirming instruction for the target comment image, wherein the target comment image is any image from the at least one candidate image.

In some embodiments, when the target image-generating entry is a text-based image-generating entry, the image description information is edited text information; and an image-generating network corresponding to the target image-generating entry is a text-based image-generating network, and the at least one candidate image is generated based on the text information and the text-based image-generating network.

In some embodiments, in a case that the target image-generating entry is an image-based image-generating entry, the image description information is a reference image as selected; and the image-generating network corresponding to the target image-generating entry is an image-based image-generating network, and the at least one candidate image is generated based on the reference image and the image-based image-generating network.

In some embodiments, in a case that the target image-generating entry is a graffiti-based image-generating entry, the image description information is a graffiti image as edited; and the image-generating network corresponding to the target image-generating entry is a graffiti-based image-generating network, and the at least one candidate image is generated based on the graffiti image and the graffiti-based image-generating network.

In some embodiments, in a case that the target image-generating entry is an image-and-text-based image-generating entry, the image description information is image-and-text information as edited; and the image-generating network corresponding to the target image-generating entry is an image-and-text-based image-generating network, and the at least one candidate image is generated based on the image-and-text information and the image-and-text-based image-generating network.

In some embodiments, the at least one candidate image includes candidate images of a plurality of first styles; and the candidate image displaying unit is configured to:
display a first candidate image and a first style switch control corresponding to each of the plurality of first styles,
wherein the first candidate image is a candidate image of a first target style in the plurality of first styles; and any first style switch control is configured to switch a currently displayed candidate image to the candidate image of the first style corresponding to the first style switch control.

In some embodiments, the at least one candidate image includes a second candidate image of a second target style in a plurality of second styles; and the candidate image displaying unit is configured to:
display the second candidate image and at least one of a displaying style adjust control, a first image update control or a second style switch control corresponding to each of the plurality of second styles,
wherein the style adjust control is configured to adjust intensity of an image style of a currently displayed candidate image; the first image update control is configured to update the currently displayed candidate image, and an image style of an updated candidate image is consistent with an image style of the currently displayed candidate image; and any second style switch control is configured to switch the currently displayed candidate image to the candidate image of the second style corresponding to the second style switch control.

In some embodiments, the second style switch control corresponding to a second non-target style, in response to being triggered for a first time, is further configured to generate a candidate image of the second non-target style; and the second non-target style is any one of the plurality of second styles except the second target style.

In some embodiments, the at least one candidate image includes a plurality of third candidate images of a third target style in a plurality of third styles; and the candidate image displaying unit is configured to:
display the plurality of third candidate images and a third style switch control corresponding to each of the plurality of third styles,
wherein any third style switch control is configured to switch a plurality of currently displayed candidate images to the plurality of candidate images of the third style corresponding to the third style switch control.

In some embodiments, the third style switch control corresponding to a third non-target style, in response to being triggered for a first time, is further configured to generate a plurality of candidate images of the third non-target style; and the third non-target style is any one of the plurality of third styles except the third target style.

In some embodiments, the at least one candidate image includes candidate images of a plurality of fourth styles; and the candidate image displaying unit is configured to:
display candidate images of the plurality of fourth styles and a second image update control,
wherein the second image update control is configured to update currently displayed candidate images of the plurality of fourth styles.

With regard to the apparatus in the above embodiments, the specific way in which the respective module performs operations has been described in detail in the embodiments of the method, and will not be elaborated in detail herein.

FIG. 16 is a block diagram of an electronic device for processing comments according to some embodiments. The electronic device is a terminal, and its internal structure diagram may be as shown in FIG. 16. The terminal includes a radio frequency (RF) circuit 1610, a memory 1620 including one or more computer-readable storage media, an input unit 1630, a display unit 1640, a sensor 1650, an audio circuit 1660, a wireless fidelity (WiFi) module 1670, a processor 1680 including one or more processing cores, a power supply 1690, and other components. It will be understood by those skilled in the art that the terminal structure shown in FIG. 16 does not constitute a limitation to the terminal. The terminal may include more or less components than those illustrated in FIG. 16, or a combination of some components, or the components arranged in a different fashion.

The RF circuit 1610 is used for receiving and sending information in an information receiving and sending process or an on-the-phone process. Specifically, after receiving downlink information of a base station, the downlink information is processed by one or more processors 1680. In addition, uplink-related data is sent to the base station. Generally, the RF circuit 1610 includes, but is not limited to, an antenna, at least one amplifier, a tuner, one or more oscillators, a subscriber identity module (SIM) card, a transceiver, a coupler, a low noise amplifier (LNA), a duplexer, and the like. In addition, the RF circuit 1610 may also be communicated with other terminals through wireless communication and a network. The wireless communication may use any communication standard or protocol, including but not limited to global system of mobile communication (GSM), general packet radio service (GPRS), code division multiple access (CDMA), wideband code division multiple access (WCDMA), long term evolution (LTE), an e-mail, short messaging service (SMS), and the like.

The memory 1620 is used for storing software programs and modules. The processor 1680 executes various functional applications and data processing by running the software programs and modules stored in the memory 1620. The memory 1620 mainly includes a program storage area and a data storage area. The program storage area may store an operating system, applications required by functions, etc. The data storage data area may store data created in accordance with the use of the terminal, etc. In addition, the memory 1620 includes a high-speed random access memory and may further include a non-volatile memory, such as at least one magnetic disk storage device, a flash memory device, or other volatile solid-state memory devices. Correspondingly, the memory 1620 further includes a memory controller to provide access of the processor 1680 and the input unit 1630 to the memory 1620.

The input unit 1630 is used for receiving input numeric or character information and generating a keyboard signal input, a mouse signal input, an operating stick signal input, an optical signal input or a trackball signal input related to user settings and function controls. Specifically, the input unit 1630 includes a touch-sensitive surface 1631 as well as other input devices 1632. The touch-sensitive surface 1631, also referred to as a touch display or touchpad, may collect touch operations of a user (such as the user using a finger, a touch pen, or any suitable object or accessory to operate thereon or nearby) on or near the touch-sensitive surface 1631, and drives the corresponding connecting apparatus according to a preset program. Optionally, the touch-sensitive surface 1631 includes two portions, namely a touch detection apparatus and a touch controller. The touch detection apparatus detects a touch orientation of the user, detects a signal brought by the touch operation, and transmits the signal to the touch controller. The touch controller receives the touch information from the touch detection apparatus, converts the touch information into a contact coordinate, and sends the contact coordinate to the processor 1680. Further, the touch controller can receive a command sent from the processor 1680 and execute the command. In addition, the touch-sensitive surface 1631 is implemented in various types such as a resistive type, a capacitive type, an infrared type, and a surface acoustic wave type. In addition to the touch-sensitive surface 1631, the input unit 1630 further includes other input devices 1632. Specifically, the input device 1632 may include, but is not limited to, one or more of a physical keyboard, a function key (such as a volume control button, and an on/off button), a trackball, a mouse, an operating stick, and the like.

The display unit 1640 is used for displaying information input by the user or information provided to the user, and various graphical user interfaces of the terminal. These graphical user interfaces may be composed of a graph, a text, an icon, a video, and any combination thereof. The display unit 1640 includes a display panel 1641. Optionally, the display panel 1641 is configured in the form of a liquid crystal display (LCD), an organic light-emitting diode (OLED), or the like. Further, the touch-sensitive surface 1631 covers the display panel 1641. When the touch-sensitive surface 1631 detects a touch operation thereon or nearby, the touch operation is transmitted to the processor 1680 to determine the type of a touch event. Then, the processor 1680 provides a corresponding visual output on the display panel 1641 according to the type of the touch event. Although the touch-sensitive surface 1631 and the display panel 1641 is implemented as two separate components to implement input and output functions, in some embodiments, the touch-sensitive surface 1631 and the display panel 1641 is also integrated to realize the input/output function.

The terminal further includes at least one type of sensor 1650, such as a light sensor, a motion sensor, and other sensors. Specifically, the light sensor may include an ambient light sensor and a proximity sensor. The ambient light sensor adjusts the brightness of the display panel 1641 according to the brightness of the ambient light. The proximity sensor enables the display panel 1641 and/or the backlight to be turned off when the terminal moves to the ear. As a kind of motion sensor, the gravity acceleration sensor may detect acceleration in all directions (generally, in three axes), may detect gravity and the direction thereof when it is stationary, and may be applied to an application (such as a horizontal and vertical screen switching, a related game, and magnetometer attitude calibration) for identifying a gesture of the terminal, a vibration recognition related function (such as a pedometer and tapping), and the like. Other sensors such as a gyroscope, a barometer, a hygrometer, a thermometer and an infrared sensor that may be mounted in the terminal are not repeated herein.

The audio circuit 1660, a speaker 1661 and a microphone 1662 provide an audio interface between the user and the terminal. The audio circuit 1660 transmits an electrical signal which is generated by converting the received audio data to the speaker 1661; and the speaker 1661 converts the electrical signal to a sound signal to be output. In addition, the microphone 1662 converts the collected sound signal into an electrical signal; after being received by the audio circuit 1660, the electrical signal is converted into audio data. After being output to and processed by the processor 1680, the audio data is sent to, for example, another terminal through the RF circuit 1610, or is output to the memory 1620 for further processing. The audio circuit 1660 further includes an earplug jack for providing communication of a peripheral earphone with the terminal.

WiFi is a short-range wireless transmission technology. With the WiFi module 1670, the terminal assists users in sending and receiving e-mails, browsing web pages, and accessing streaming media, which provides wireless broadband Internet access for the users. Although FIG. 16 shows the WiFi module 1670, it can be understood that the WiFi module 1670 is not an essential configuration of the terminal, and may be omitted as needed within the scope without changing the essence of the present disclosure.

The processor 1680 is a control center of the terminal, and is connected to all portions of the whole terminal by using various interfaces and lines. By running or executing software programs and/or modules stored in the memory 1620, and recalling data stored in the memory 1620, the processor 1680 executes various functions of the terminal and processes data so as to comprehensively monitor the terminal. Optionally, the processor 1680 includes one or more processing cores. Preferably, the processor 1680 integrates an application processor and a modem processor. The application processor mainly processes an operating system, a user interface, an application, and the like. The modem processor mainly processes wireless communications. It can be understood that the above modem processor may not be integrated into the processor 1680.

The terminal further includes a power supply 1690 (such as a battery) for supplying power to the all components. Preferably, the power supply is in logic connection to the processor 1680 through a power supply management system to manage functions such as charging, discharging, and power management through the power supply management system. The power supply 1690 further includes any of one or more DC or AC power supplies, a recharging system, a power failure detection circuit, a power converter or inverter, a power status indicator, and the like.

Although not shown, the terminal further includes a camera, a Bluetooth module, and the like, which are not repeated herein. Specifically, in the embodiment, the display unit of the terminal is a touch screen display. The terminal further includes a memory, and one or more programs. The one or more programs are stored in the memory, are configured to be executed by the one or more processors to realize instructions in the embodiments of the method of the present disclosure.

Some embodiments of the present disclosure also provide an electronic device. The electronic device includes a processor and a memory configured to store instructions that, when executed by the processor, cause the processor to:
display a plurality of image-generating entries on a comment editing panel of a comment object,
wherein the plurality of image-generating entries is configured to generate comment images for commenting the comment object by triggering different image-generating networks; each image-generating entry corresponds to an image-generating network, and the image-generating entry is configured to generate a comment image by triggering the image-generating network corresponding to the image-generating network.

In some embodiments, the plurality of image-generating entries includes at least two of a text-based image-generating entry, an image-based image-generating entry, a graffiti-based image-generating entry and an image-and-text-based image-generating entry.

In some embodiments, the instructions further cause the processor to:
display the comment editing panel provided with the plurality of image-generating entries in response to a comment triggering instruction for the comment object.

In some embodiments, the instructions further cause the processor to:
display an initial comment editing panel in response to a comment triggering instruction for the comment object, wherein the initial comment editing panel is provided with entry triggering information; and
update the initial comment editing panel as the comment editing panel provided with the plurality of image-generating entries in response to an entry displaying instruction triggered based on the entry triggering information.

In some embodiments, the instructions further cause the processor to:
display a target comment image on the comment editing panel in response to generating the target comment image by triggering a target image-generating entry, wherein the target image-generating entry is any one of the plurality of image-generating entries, and the target comment image is generated based on an image-generating network corresponding to the target image-generating entry; and
display, in response to a comment posting instruction, comment information including the target comment image on a comment displaying region of the comment object.

In some embodiments, the instructions further cause the processor to:
display operation information in response to triggering an image-generating triggering instruction based on the target image-generating entry;
in response to acquiring image description information by editing based on the operation information and triggering an image-generating confirming instruction, display at least one candidate image, wherein the at least one candidate image is generated based on the image description information and the image-generating network corresponding to the target image-generating entry; and
display the target comment image on the comment editing panel in response to an image confirming instruction for the target comment image, wherein the target comment image is any image from the at least one candidate image.

In some embodiments, in a case that the target image-generating entry is a text-based image-generating entry, the image description information is text information as edited; and the image-generating network corresponding to the target image-generating entry is a text-based image-generating network, and the at least one candidate image is generated based on the text information and the text-based image-generating network.

In some embodiments, in a case that the target image-generating entry is an image-based image-generating entry, the image description information is a reference image as selected; and the image-generating network corresponding to the target image-generating entry is an image-based image-generating network, and the at least one candidate image is generated based on the reference image and the image-based image-generating network.

In some embodiments, in a case that the target image-generating entry is a graffiti-based image-generating entry, the image description information is a graffiti image as edited; and the image-generating network corresponding to the target image-generating entry is a graffiti-based image-generating network, and the at least one candidate image is generated based on the graffiti image and the graffiti-based image-generating network.

In some embodiments, in a case that the target image-generating entry is an image-and-text-based image-generating entry, the image description information is image-and-text information as edited; and the image-generating network corresponding to the target image-generating entry is an image-and-text-based image-generating network, and the at least one candidate image is generated based on the image-and-text information and the image-and-text-based image-generating network.

In some embodiments, the at least one candidate image includes candidate images of a plurality of first styles; and the instructions further cause the processor to:
display a first candidate image and a first style switch control corresponding to each of the plurality of first styles,
wherein the first candidate image is a candidate image of a first target style in the plurality of first styles; and any first style switch control is configured to switch a currently displayed candidate image to the candidate image of the first style corresponding to the first style switch control.

In some embodiments, the at least one candidate image includes a second candidate image of a second target style in a plurality of second styles; and the instructions further cause the processor to:
display the second candidate image and at least one of a displaying style adjust control, a first image update control or a second style switch control corresponding to each of the plurality of second styles,
wherein the style adjust control is configured to adjust intensity of an image style of a currently displayed candidate image; the first image update control is configured to update the currently displayed candidate image, and an image style of an updated candidate image is consistent with an image style of the currently displayed candidate image; and any second style switch control is configured to switch the currently displayed candidate image to the candidate image of the second style corresponding to the second style switch control.

In some embodiments, the second style switch control corresponding to a second non-target style, in response to being triggered for a first time, is further configured to generate a candidate image of the second non-target style; and the second non-target style is any one of the plurality of second styles except the second target style.

In some embodiments, the at least one candidate image includes a plurality of third candidate images of a third target style in a plurality of third styles; and the instructions further cause the processor to:
display the plurality of third candidate images and a third style switch control corresponding to each of the plurality of third styles,
wherein any third style switch control is configured to switch a plurality of currently displayed candidate images to the plurality of candidate images of the third style corresponding to the third style switch control.

In some embodiments, the third style switch control corresponding to a third non-target style, in response to being triggered for a first time, is further configured to generate a plurality of candidate images of the third non-target style; and the third non-target style is any one of the plurality of third styles except the third target style.

In some embodiments, the at least one candidate image includes candidate images of a plurality of fourth styles; and the instructions further cause the processor to:
display candidate images of the plurality of fourth styles and a second image update control,
wherein the second image update control is configured to update currently displayed candidate images of the plurality of fourth styles.

Some embodiment of the present disclosure also provides a non-transitory computer-readable storage medium storing instructions that, when executed by a processor of an electronic device, cause the electronic device to:
display a plurality of image-generating entries on a comment editing panel of a comment object,
wherein the plurality of image-generating entries is configured to generate comment images for commenting the comment object by triggering different image-generating networks; each image-generating entry corresponds to an image-generating network, and the image-generating entry is configured to generate a comment image by triggering the image-generating network corresponding to the image-generating network.

In some embodiments, the plurality of image-generating entries includes at least two of a text-based image-generating entry, an image-based image-generating entry, a graffiti-based image-generating entry and an image-and-text-based image-generating entry.

In some embodiments, the instructions further cause the electronic device to:
display the comment editing panel provided with the plurality of image-generating entries in response to a comment triggering instruction for the comment object.

In some embodiments, the instructions further cause the electronic device to:
display an initial comment editing panel in response to a comment triggering instruction for the comment object, wherein the initial comment editing panel is provided with entry triggering information; and
update the initial comment editing panel as the comment editing panel provided with the plurality of image-generating entries in response to an entry displaying instruction triggered based on the entry triggering information.

In some embodiments, the instructions further cause the electronic device to:
display a target comment image on the comment editing panel in response to generating the target comment image by triggering a target image-generating entry, wherein the target image-generating entry is any one of the plurality of image-generating entries, and the target comment image is generated based on an image-generating network corresponding to the target image-generating entry; and
display, in response to a comment posting instruction, comment information including the target comment image on a comment displaying region of the comment object.

In some embodiments, the instructions further cause the electronic device to:
display operation information in response to triggering an image-generating triggering instruction based on the target image-generating entry;
in response to acquiring image description information by editing based on the operation information and triggering an image-generating confirming instruction, display at least one candidate image, wherein the at least one candidate image is generated based on the image description information and the image-generating network corresponding to the target image-generating entry; and
display the target comment image on the comment editing panel in response to an image confirming instruction for the target comment image, wherein the target comment image is any image from the at least one candidate image.

In some embodiments, in a case that the target image-generating entry is a text-based image-generating entry, the image description information is text information as edited; and the image-generating network corresponding to the target image-generating entry is a text-based image-generating network, and the at least one candidate image is generated based on the text information and the text-based image-generating network.

In some embodiments, in a case that the target image-generating entry is an image-based image-generating entry, the image description information is a reference image as selected; and the image-generating network corresponding to the target image-generating entry is an image-based image-generating network, and the at least one candidate image is generated based on the reference image and the image-based image-generating network.

In some embodiments, in a case that the target image-generating entry is a graffiti-based image-generating entry, the image description information is a graffiti image as edited; and the image-generating network corresponding to the target image-generating entry is a graffiti-based image-generating network, and the at least one candidate image is generated based on the graffiti image and the graffiti-based image-generating network.

In some embodiments, in a case that the target image-generating entry is an image-and-text-based image-generating entry, the image description information is image-and-text information as edited; and the image-generating network corresponding to the target image-generating entry is an image-and-text-based image-generating network, and the at least one candidate image is generated based on the image-and-text information and the image-and-text-based image-generating network.

In some embodiments, the at least one candidate image includes candidate images of a plurality of first styles; and the instructions further cause the electronic device to:
displaying a first candidate image and a first style switch control corresponding to each of the plurality of first styles,
wherein the first candidate image is a candidate image of a first target style in the plurality of first styles; and any first style switch control is configured to switch a currently displayed candidate image to the candidate image of the first style corresponding to the first style switch control.

In some embodiments, the at least one candidate image includes a second candidate image which is a candidate image of a second target style in a plurality of second styles; and the instructions further cause the electronic device to:
display the second candidate image and at least one of a displaying style adjust control, a first image update control or a second style switch control corresponding to each of the plurality of second styles,
wherein the style adjust control is configured to adjust intensity of an image style of a currently displayed candidate image; the first image update control is configured to update the currently displayed candidate image, and an image style of an updated candidate image is consistent with an image style of the currently displayed candidate image; and any second style switch control is configured to switch the currently displayed candidate image to the candidate image of the second style corresponding to the second style switch control.

In some embodiments, the second style switch control corresponding to a second non-target style, in response to being triggered for the first time, is further configured to generate a candidate image of the second non-target style; and the second non-target style is any one of the plurality of second styles except the second target style.

In some embodiments, the at least one candidate image includes a plurality of third candidate images of a third target style in a plurality of third styles; and the instructions further cause the electronic device to:
display the plurality of third candidate images and a third style switch control corresponding to each of the plurality of third styles,
wherein any third style switch control is configured to switch a plurality of currently displayed candidate images to the plurality of candidate images of the third style corresponding to the third style switch control.

In some embodiments, the third style switch control corresponding to a third non-target style, in response to being triggered for the first time, is further configured to generate a plurality of candidate images of the third non-target style; and the third non-target style is any one of the plurality of third styles except the third target style.

In some embodiments, the at least one candidate image includes candidate images of a plurality of fourth styles; and the instructions further cause the electronic device to:
display candidate images of the plurality of fourth styles and a second image update control,
wherein the second image update control is configured to update currently displayed candidate images of the plurality of fourth styles.

An embodiment of the present disclosure also provides a computer program product including instructions. When the instructions in the computer program product run in an electronic device, the electronic device is caused to:
display a plurality of image-generating entries on a comment editing panel of a comment object,
wherein the plurality of image-generating entries is configured to generate comment images for commenting the comment object by triggering different image-generating networks; each image-generating entry corresponds to an image-generating network, and the image-generating entry is configured to generate a comment image by triggering the image-generating network corresponding to the image-generating network.

In some embodiments, the plurality of image-generating entries includes at least two of a text-based image-generating entry, an image-based image-generating entry, a graffiti-based image-generating entry and an image-and-text-based image-generating entry.

In some embodiments, when the instructions in the computer program product run in the electronic device, the electronic device is further caused to:
display the comment editing panel provided with the plurality of image-generating entries in response to a comment triggering instruction for the comment object.

In some embodiments, when the instructions in the computer program product run in the electronic device, the electronic device is further caused to:
display an initial comment editing panel in response to a comment triggering instruction for the comment object, wherein the initial comment editing panel is provided with entry triggering information; and
update the initial comment editing panel as the comment editing panel provided with the plurality of image-generating entries in response to an entry displaying instruction triggered based on the entry triggering information.

In some embodiments, when the instructions in the computer program product run in the electronic device, the electronic device is further caused to:
display a target comment image on the comment editing panel in response to generating the target comment image by triggering a target image-generating entry, wherein the target image-generating entry is any one of the plurality of image-generating entries, and the target comment image is generated based on an image-generating network corresponding to the target image-generating entry; and
display, in response to a comment posting instruction, comment information including the target comment image on a comment displaying region of the comment object.

In some embodiments, when the instructions in the computer program product run in the electronic device, the electronic device is caused to:
display operation information in response to triggering an image-generating triggering instruction based on the target image-generating entry;
in response to acquiring image description information by editing based on the operation information and triggering an image-generating confirming instruction, display at least one candidate image, wherein the at least one candidate image is generated based on the image description information and the image-generating network corresponding to the target image-generating entry; and
display the target comment image on the comment editing panel in response to an image confirming instruction for the target comment image, wherein the target comment image is any image from the at least one candidate image.

In some embodiments, in a case that the target image-generating entry is a text-based image-generating entry, the image description information is text information as edited; and the image-generating network corresponding to the target image-generating entry is a text-based image-generating network, and the at least one candidate image is generated based on the text information and the text-based image-generating network.

In some embodiments, in a case that the target image-generating entry is an image-based image-generating entry, the image description information is a reference image as selected; and the image-generating network corresponding to the target image-generating entry is an image-based image-generating network, and the at least one candidate image is generated based on the reference image and the image-based image-generating network.

In some embodiments, in a case that the target image-generating entry is a graffiti-based image-generating entry, the image description information is a graffiti image as edited; and the image-generating network corresponding to the target image-generating entry is a graffiti-based image-generating network, and the at least one candidate image is generated based on the graffiti image and the graffiti-based image-generating network.

In some embodiments, in a case that the target image-generating entry is an image-and-text-based image-generating entry, the image description information is image-and-text information as edited; and the image-generating network corresponding to the target image-generating entry is an image-and-text-based image-generating network, and the at least one candidate image is generated based on the image-and-text information and the image-and-text-based image-generating network.

In some embodiments, the at least one candidate image includes candidate images of a plurality of first styles; and when instructions in the computer program product are run on an electronic device, the electronic device is caused to:
display a first candidate image and a first style switch control corresponding to each of the plurality of first styles,
wherein the first candidate image is a candidate image of a first target style in the plurality of first styles; and any first style switch control is configured to switch a currently displayed candidate image to the candidate image of the first style corresponding to the first style switch control.

In some embodiments, the at least one candidate image includes a second candidate image of a second target style in a plurality of second styles; and when instructions in the computer program product are run on an electronic device, the electronic device is caused to:
display the second candidate image and at least one of a displaying style adjust control, a first image update control or a second style switch control corresponding to each of the plurality of second styles,
wherein the style adjust control is configured to adjust intensity of an image style of a currently displayed candidate image; the first image update control is configured to update the currently displayed candidate image, and an image style of an updated candidate image is consistent with an image style of the currently displayed candidate image; and any second style switch control is configured to switch the currently displayed candidate image to the candidate image of the second style corresponding to the second style switch control.

In some embodiments, the second style switch control corresponding to a second non-target style, in response to being triggered for the first time, is further configured to generate a candidate image of the second non-target style; and the second non-target style is any one of the plurality of second styles except the second target style.

In some embodiments, the at least one candidate image includes a plurality of third candidate images, which are candidate images of a third target style in a plurality of third styles; and when instructions in the computer program product are run on an electronic device, the electronic device is caused to:
display the plurality of third candidate images and a third style switch control corresponding to each of the plurality of third styles,
wherein any third style switch control is configured to switch a plurality of currently displayed candidate images to the plurality of candidate images of the third style corresponding to the third style switch control.

In some embodiments, the third style switch control corresponding to a third non-target style, in response to being triggered for the first time, is further configured to generate a plurality of candidate images of the third non-target style; and the third non-target style is any one of the plurality of third styles except the third target style.

In some embodiments, the at least one candidate image includes candidate images of a plurality of fourth styles; and when instructions in the computer program product are run on an electronic device, the electronic device is caused to:
display candidate images of the plurality of fourth styles and a second image update control,
wherein the second image update control is configured to update currently displayed candidate images of the plurality of fourth styles.

It can be understood by those ordinary skilled in the art that all or part of the processes in the method according to the above embodiments can be completed by instructing related hardware through a computer program, the computer program can be stored in a non-transitory computer-readable storage medium, and the computer program, when executed, can include the processes of the above respective method embodiments. Any reference to the memory, storage, database or other mediums used in respective embodiments according to the present application can include a non-transitory and/or a transitory memory. The non-transitory memory includes a read-only memory (ROM), a programmable ROM (PROM), an electrically programmable ROM (EPROM), an electrically erasable programmable ROM (EEPROM) or a flash memory. The volatile memory includes a random access memory (RAM) or an external cache memory. By way of illustration and not limitation, the RAM is available in various forms, such as a static RAM (SRAM), a dynamic RAM (DRAM), a synchronous DRAM (SDRAM), a double data rate SDRAM (DDRSDRAM), an enhanced SDRAM (ESDRAM), a synchronous link (Synchlink) DRAM (SLDRAM), a memory bus (Rambus) direct RAM (RDRAM), a direct memory bus dynamic RAM (DRDRAM), a memory bus dynamic RAM (RDRAM), etc.

Some embodiments of the present disclosure also provide a method for processing comments. The method includes:
displaying a plurality of preset image-generating entries on a comment editing panel of a target comment object,
wherein the plurality of preset image-generating entries is configured to generate comment images corresponding to the target comment object by triggering different image-generating networks, each preset image-generating entry is configured to generate a corresponding comment image by triggering a preset image-generating network corresponding to the preset image-generating network.

In some embodiments, the plurality of preset image-generating entries includes at least two of a text-based image-generating entry, an image-based image-generating entry, a graffiti-based image-generating entry and an image-and-text-based image-generating entry.

In some embodiments, displaying the plurality of preset image-generating entries on the comment editing panel of the target comment object includes:
displaying the comment editing panel provided with the plurality of preset image-generating entries in response to a comment triggering instruction for the target comment object.

In some embodiments, the method further includes:
displaying an initial comment editing panel in response to a comment triggering instruction for the target comment object, wherein the initial comment editing panel is provided with image-generating entry triggering information; and
displaying the plurality of preset image-generating entries on the comment editing panel of the target comment object includes:
updating the initial comment editing panel as the comment editing panel displaying the plurality of preset image-generating entries in response to an image-generating entry displaying instruction triggered by based on image-generating entry triggering information.

In some embodiments, the method further includes:
displaying the target comment image on the comment editing panel in response to generating a target comment image corresponding to the target comment object by triggering a target image-generating entry, wherein the target image-generating entry is any one of the plurality of preset image-generating entries, and the target comment image is generated based on a preset image-generating network corresponding to the target image-generating entry; and
displaying, in response to a comment posting instruction, comment information including the target comment image on a comment displaying region corresponding to the target comment object.

In some embodiments, displaying the target comment image on the comment editing panel in response to generating the target comment image corresponding to the target comment object by triggering the target image-generating entry includes:
displaying image-generating editing operation information in response to triggering an image-generating triggering instruction based on the target image-generating entry;
in response to acquiring image description information by editing based on the image-generating editing operation information and triggering an image-generating confirming instruction, displaying at least one generated image, wherein the at least one generated image is an image generated based on the image description information and the preset image-generating network corresponding to the target image-generating entry; and
displaying the target comment image on the comment editing panel in response to an image confirming instruction for the target comment image, wherein the target comment image is any image from the at least one generated image.

In some embodiments, in the case that the target image-generating entry is a text-based image-generating entry, the image description information is edited text information; and a preset image-generating network corresponding to the target image-generating entry is a text-based image-generating network, and the at least one generated image is an image generated based on the edited text information and the text-based image-generating network.

In some embodiments, in the case that the target image-generating entry is an image-based image-generating entry, the image description information is a selected image; and a preset image-generating network corresponding to the target image-generating entry is an image-based image-generating network, and the at least one generated image is an image generated based on the selected image and the image-based image-generating network.

In some embodiments, in the case that the target image-generating entry is a graffiti-based image-generating entry, the image description information is an edited graffiti image; and a preset image-generating network corresponding to the target image-generating entry is a graffiti-based image-generating network, and the at least one generated image is an image generated based on the edited graffiti image and the graffiti-based image-generating network.

In some embodiments, in the case that the target image-generating entry is an image-and-text-based image-generating entry, the image description information is edited image-and-text information; and a preset image-generating network corresponding to the target image-generating entry is an image-and-text-based image-generating network, and the at least one generated image is an image generated based on the edited image-and-text information and the image-and-text-based image-generating network.

In some embodiments, the at least one generated image includes a plurality of first generated images, which is generated images of a plurality first preset styles; and displaying the at least one generated image includes:
displaying a target generated image and a first style switch control corresponding to each of the plurality of first preset styles,
wherein the target generated image is a generated image of a first target style in the plurality of first preset styles; any first style switch control is configured to switch a currently displayed generated image to the generated image of the first preset style corresponding to the first style switch control.

In some embodiments, the at least one generated image includes an initially generated image; an image style of the initially generated image is a second target style in a plurality of second preset styles; and displaying the at least one generated image includes:
displaying the initially generated image, a style adjust control, a first image update control and a second style switch control corresponding each of the plurality of second preset styles;
wherein the style adjust control is used for adjusting intensity of an image style of a currently displayed generated image; the first image update control is used for updating the currently displayed generated image, and the image style of the currently displayed generated image is consistent with an image style of the updated generated image; and any second style switch control is used for switching the currently displayed generated image to an generated image of the second preset style corresponding to the second style switch control. In addition, the second style switch control corresponding to a first another style, in response to being triggered for the first time, is further used for generating a to-be-generated image of the first another style; and the first another style is any one of the second preset styles except the second target style.

In some embodiments, the at least one generated image includes a plurality of current generated images of a third target style in a plurality of third preset styles, and displaying the at least one generated image includes:
displaying the plurality of currently generated images and a third style switch control corresponding to each of the plurality of third preset styles,
wherein any third style switch control is used for switching a plurality of currently displayed generated images to a plurality of generated images of the third preset style corresponding to the third style switch control. In addition, the third style switch control corresponding to a second another style, in response to being triggered for the first time, is further used for generating a plurality of to-be-generated images of the second another style; and the second another style is any one of the third preset styles except the third target style.

In some embodiments, the at least one generated image includes a plurality of second generated images which are generated images of a plurality of fourth preset styles; and displaying the at least one generated image includes:
displaying the plurality of second generated images and a second image update control,
wherein the second image update control is used for updating currently displayed generated images of the plurality of fourth preset styles.

All the embodiments of the present disclosure may be executed alone or in combination with other embodiments, which are regarded as the protection scope of the present disclosure.

What is claimed is:

1. A method for processing comments, comprising:
displaying a plurality of image-generating entries on a comment editing panel of a comment object,
wherein the plurality of image-generating entries is configured to generate comment images for commenting on the comment object by triggering a plurality of image-generating networks,
wherein each image-generating entry of the plurality of image-generating entries corresponds to an image-generating network of the plurality of image-generating networks, and
wherein each image-generating entry is configured to generate a comment image by triggering the image-generating network corresponding to the each image-generating entry.

2. The method according to claim 1, wherein the plurality of image-generating entries comprises at least two of a text-based image-generating entry, an image-based image-generating entry, a graffiti-based image-generating entry, or an image-and-text-based image-generating entry.

3. The method according to claim 1, wherein displaying the plurality of image-generating entries on the comment editing panel of the comment object comprises:
displaying the comment editing panel provided with the plurality of image-generating entries in response to a comment triggering instruction for the comment object.

4. The method according to claim 1, further comprising:
displaying an initial comment editing panel in response to a comment triggering instruction for the comment object, wherein the initial comment editing panel is provided with entry triggering information; and
displaying the plurality of image-generating entries on the comment editing panel of the comment object comprising:
updating the initial comment editing panel to the comment editing panel provided with the plurality of image-generating entries in response to an entry displaying instruction triggered by the entry triggering information.

5. The method according to claim 1, further comprising:
displaying a target comment image on the comment editing panel in response to generating the target comment image by triggering a target image-generating entry, wherein the target image-generating entry is any one of the plurality of image-generating entries, and the target comment image is generated based on an image-generating network corresponding to the target image-generating entry; and
displaying, in response to a comment posting instruction, comment information comprising the target comment image on a comment displaying region of the comment object.

6. The method according to claim 5, wherein displaying the target comment image on the comment editing panel in response to generating the target comment image by triggering the target image-generating entry comprises:
displaying operation information in response to triggering an image-generating triggering instruction based on the target image-generating entry;
in response to acquiring image description information by editing based on the operation information and triggering an image-generating confirming instruction, displaying at least one candidate image, wherein the at least one candidate image is generated based on the image description information and the image-generating network corresponding to the target image-generating entry; and
displaying the target comment image on the comment editing panel in response to an image confirming instruction for the target comment image, wherein the target comment image is any image from the at least one candidate image.

7. The method according to claim 6, wherein:
in response to the target image-generating entry being a text-based image-generating entry, the image description information is text information as edited; and
in response to the image-generating network corresponding to the target image-generating entry being a text-based image-generating network, the at least one candidate image is generated based on the text information and the text-based image-generating network.

8. The method according to claim 6, wherein:
in response to the target image-generating entry being an image-based image-generating entry, the image description information is a reference image as selected; and
in response to the image-generating network corresponding to the target image-generating entry being an image-based image-generating network, the at least one candidate image is generated based on the reference image and the image-based image-generating network.

9. The method according to claim 6, wherein:
in response to the target image-generating entry being a graffiti-based image-generating entry, the image description information is a graffiti image as edited; and
in response to the image-generating network corresponding to the target image-generating entry being a graffiti-based image-generating network, the at least one candidate image is generated based on the graffiti image and the graffiti-based image-generating network.

10. The method according to claim 6, wherein:
in response to the target image-generating entry being an image-and-text-based image-generating entry, the image description information is image-and-text information as edited; and
in response to the image-generating network corresponding to the target image-generating entry being an image-and-text-based image-generating network, the at least one candidate image is generated based on the image-and-text information and the image-and-text-based image-generating network.

11. The method according to claim 6, wherein the at least one candidate image comprises candidate images of a plurality of first styles, and wherein displaying the at least one candidate image comprises:
displaying a first candidate image and a first style switch control corresponding to each of the plurality of first styles,
wherein the first candidate image is a candidate image of a first target style of the plurality of first styles, and any first style switch control is configured to switch a currently displayed candidate image to the candidate image of the first style corresponding to the first style switch control.

12. The method according to claim 6, wherein the at least one candidate image comprises a second candidate image of a second target style of a plurality of second styles, and wherein displaying the at least one candidate image comprises:
displaying the second candidate image and at least one of a displaying style adjust control, a first image update control, or a second style switch control corresponding to each of the plurality of second styles,
wherein the style adjust control is configured to adjust an intensity of an image style of a currently displayed candidate image,
wherein the first image update control is configured to update the currently displayed candidate image to an updated candidate image, and an image style of the updated candidate image is consistent with an image style of the currently displayed candidate image, and
wherein the corresponding second style switch control is configured to switch the currently displayed candidate image to the candidate image of the second style corresponding to the second style switch control.

13. The method according to claim 12, wherein the second style switch control corresponding to a second non-target style is further configured to, in response to being triggered for a first time, generate a candidate image of the second non-target style, and wherein the second non-target style is any one of the plurality of second styles is different from the second target style.

14. The method according to claim 6, wherein the at least one candidate image comprises a plurality of third candidate images of a third target style of a plurality of third styles, and wherein displaying the at least one candidate image comprises:
displaying the plurality of third candidate images and a third style switch control corresponding to each of the plurality of third styles,
wherein any third style switch control is configured to switch a plurality of currently displayed candidate images to the each of the plurality of candidate images of the third style using the corresponding to the third style switch control.

15. The method according to claim 14, wherein the third style switch control corresponding to a third non-target style is further configured to, in response to being triggered for a first time, generate a plurality of candidate images of the third non-target style, and wherein the third non-target style is one of the plurality of third styles is different from the third target style.

16. The method according to claim 6, wherein the at least one candidate image comprises candidate images of a plurality of fourth styles; and wherein displaying the at least one candidate image comprises:
displaying the candidate images of the plurality of fourth styles and a second image update control,
wherein the second image update control is configured to update currently displayed candidate images of the plurality of fourth styles.

17. An electronic device, comprising:
a processor; and
a memory configured to store instructions that, when executed by the processor, cause the processor to:
display a plurality of image-generating entries on a comment editing panel of a comment object,
wherein the plurality of image-generating entries is configured to generate comment images for commenting on the comment object by triggering a plurality of image-generating networks,
wherein each image-generating entry of the plurality of image-generating entries corresponds to an image-generating network of the plurality of image-generating networks, and
wherein each image-generating entry is configured to generate a comment image by triggering the image-generating network corresponding to the each image-generating entry.

18. The electronic device according to claim 17, wherein the plurality of image-generating entries comprises at least two of a text-based image-generating entry, an image-based image-generating entry, a graffiti-based image-generating entry, or an image-and-text-based image-generating entry.

19. The electronic device according to claim 17, wherein the instructions further cause the processor to:
display the comment editing panel provided with the plurality of image-generating entries in response to a comment triggering instruction for the comment object.

20. A non-transitory computer-readable storage medium storing instructions that, when executed by a processor of an electronic device, cause the electronic device to:
display a plurality of image-generating entries on a comment editing panel of a comment object,
wherein the plurality of image-generating entries is configured to generate comment images for commenting on the comment object by triggering a plurality of image-generating networks,
wherein each image-generating entry of the plurality of image-generating entries corresponds to an image-generating network of the plurality of image-generating networks, and
wherein each image-generating entry is configured to generate a comment image by triggering the image-generating network corresponding to the each image-generating entry.
